(19) United States
(12) Patent Application Publication
(10) Pub. No.: US 2006/0235717 A1
(43) Pub. Date: Oct. 19, 2006

(54) Method and system for manufacturing solar panels using an integrated solar cell using a plurality of photovoltaic regions

(75) Inventors: Suvi Sharma, Berkeley, CA (US); Kevin R. Gibson, Redwood City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Solaria Corporation, Sunnyvale, CA (US)

(21) Appl. No.: 11/354,530

(22) Filed: Feb. 14, 2006

Related U.S. Application Data
(60) Provisional application No. 60/702,728, filed on Jul. 26, 2005.
(60) Provisional application No. 60/672,815, filed on Apr. 18, 2005.

(51) Int. Cl. G06Q 99/00

(52) U.S. Cl. 705/1; 136/244; 438/57

(57) ABSTRACT

A method and system for manufacturing solar panels using an integrated solar cell using a plurality of photovoltaic regions. The method includes purchasing a first photovoltaic solar cell from a first entity for a first value. The method includes dicing the photovoltaic solar cell into a plurality of photovoltaic regions that may be characterized as a photodiodes. The method includes assembling a second photovoltaic solar cell. The second photovoltaic solar cell includes a first substrate member including a first substrate surface, one or more photovoltaic regions spatially disposed overlying the first substrate surface. One or more concentrator elements are respectively coupled to the one or more photovoltaic regions. An encapsulating material is provided between each of the photovoltaic regions and each of the concentrator elements. The method includes transferring the second photovoltaic solar cell to a second entity for a second value that is less than 79% of the first value.

### CROSS-REFERENCES TO RELATED APPLICATIONS

This application claims priority to U.S. Provisional No. 60/702,728 (Attorney Docket Number 025902-000300US) filed Jul. 26, 2005, the name of Kevin R. Gibson which is related to U.S. Provisional No. 60/672,815 (Attorney Docket Number 025902-000100US) filed Apr. 18, 2005, in the name of Kevin R. Gibson (herein “Gibson”), commonly assigned, and hereby incorporated by reference here.

### BACKGROUND OF THE INVENTION

The present invention relates generally to solar energy techniques. More particularly, the present invention provides a method and resulting solar panel apparatus fabricated from a solar cell including a plurality of photovoltaic regions provided within one or more substrate members. Merely by way of example, the invention has been applied to a solar cell including the plurality of photovoltaic regions, but it would be recognized that the invention has a much broader range of applicability.

As the population of the world increases, industrial expansion has lead to an equally large consumption of energy. Energy often comes from fossil fuels, including coal and oil, hydroelectric plants, nuclear sources, and others. As merely an example, the International Energy Agency projects further increases in oil consumption, with developing nations such as China and India accounting for most of the increase. Almost every element of our daily lives depends, in part, on oil, which is becoming increasingly scarce. As time further progresses, an era of “cheap” and plentiful oil is coming to an end. Accordingly, other and alternative sources of energy have been developed.

Concurrent with oil, we have also relied upon other very useful sources of energy such as hydroelectric, nuclear, and the like to provide our electricity needs. As an example, most of our conventional electricity requirements for home and business use comes from turbines run on coal or other forms of fossil fuel, nuclear power generation plants, and hydroelectric plants, as well as other forms of renewable energy. Often times, home and business use of electrical power has been stable and widespread.

Most importantly, much if not all of the useful energy found on the Earth comes from our sun. Generally all common plant life on the Earth achieves life using photosynthesis processes from sun light. Fossil fuels such as oil were also developed from biological materials derived from energy associated with the sun. For human beings including “sun worshipers,” sunlight has been essential. For life on the planet Earth, the sun has been our most important energy source and fuel for modern day solar energy.

Solar energy possesses many characteristics that are very desirable! Solar energy is renewable, clean, abundant, and often widespread. Certain technologies developed often capture solar energy, concentrate it, store it, and convert it into other useful forms of energy.

Solar panels have been developed to convert sunlight into energy. As merely an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Although solar panels have been used successful for certain applications, there are still certain limitations. Solar cells are often costly. Depending upon the geographic region, there are often financial subsidies from governmental entities for purchasing solar panels, which often cannot compete with the direct purchase of electricity from public power companies. Additionally, the panels are often composed of silicon bearing wafer materials. Such wafer materials are often costly and difficult to manufacture efficiently on a large scale. Availability of solar panels is also somewhat scarce. That is, solar panels are often difficult to find and purchase from limited sources of photovoltaic silicon bearing materials. These and other limitations are described throughout the present specification, and may be described in more detail below.

From the above, it is seen that techniques for improving solar devices is highly desirable.

### BRIEF SUMMARY OF THE INVENTION

According to the present invention, techniques related to solar energy are provided. More particularly, the present invention provides a method and resulting solar panel apparatus fabricated from a solar cell including a plurality of photovoltaic regions provided within one or more substrate members. Merely by way of example, the invention has been applied to a solar cell including the plurality of photovoltaic regions, but it would be recognized that the invention has a much broader range of applicability.

In a specific embodiment, the present invention provides a method for manufacturing solar panels. The method includes a step for purchasing a first photovoltaic solar cell from a first entity for a first value. Additionally, the method includes dicing the photovoltaic solar cell into a plurality of photovoltaic regions, each of the photovoltaic regions being characterized as a photodiode. The method also includes assembling a second photovoltaic solar cell. The second photovoltaic solar cell includes a first substrate member including a first substrate surface, one or more photovoltaic regions spatially disposed overlying the first substrate surface. One or more concentrator elements are respectively coupled to the one or more photovoltaic regions. An encapsulating material is provided between each of the photovoltaic regions and each of the concentrator elements. The method additionally includes transferring the second photovoltaic solar cell to a second entity for a second value, the second value being less than 79% of the first value.

In an alternative embodiment, the present invention provides a method for manufacturing solar panels. The method includes transferring a first photovoltaic solar cell from a first entity to a second entity at a first time. Additionally, the method includes storing the first photovoltaic solar cell at the second entity. Moreover, the method includes a step of dicing the photovoltaic solar cell into a plurality of photovoltaic regions. Each of the photovoltaic regions may be characterized as a photodiode. In addition, the method includes assembling a second photovoltaic solar cell. The second photovoltaic solar cell includes a first substrate member including a first substrate surface, one or more photovoltaic regions spatially disposed overlying the first substrate surface, one or more concentrator elements respectively coupled to the one or more photovoltaic regions, and an encapsulating material provided between each of the photovoltaic regions and each of the concentrator elements. The method additionally includes the step of transferring the second photovoltaic solar cell from the second entity to a third entity, and transferring a first value from the first entity to the second entity. The first value is associated with at least the assembling the second photovoltaic cell by the second entity.

In an alternative embodiment, the present invention provides a system for manufacturing solar panels. The system includes a manufacturing network that is configured to exchange data. The system additionally includes a server configured to store and provide data for a plurality of manufacturing settings, the server being connected to the manufacturing network. The system also includes a user terminal that is configured to provide user interface for a user to create and modify the plurality of manufacturing settings. Moreover, the system includes a purchasing module configured to purchase a photovoltaic cell from a first entity in accordance to the plurality of manufacturing settings, which are obtained from the server over the manufacturing network. The system also includes a dicing module configured to dice first photovoltaic cell into a first plurality of photovoltaic regions. Photovoltaic regions are associated with a first predetermined photovoltaic shape in accordance to the plurality of manufacturing settings, which may be obtained from the server over the manufacturing network. In addition, the system includes an assembling module configured to assemble a second photovoltaic cell using one of more photovoltaic regions in accordance to the plurality of manufacturing settings, which are obtained from the server over the manufacturing network. The system also includes a transferring module configured to transfer the second photovoltaic cell to a second entity for a second value in accordance to the plurality of manufacturing settings, which may be obtained from the server over the manufacturing network. According to an embodiment, the second value is less than 79% of the first value.

Many benefits are achieved by way of the present invention over conventional techniques. For example, the present technique provides an easy to use process that relies upon conventional technology such as silicon materials, although other materials can also be used. Additionally, the method provides a process that is compatible with conventional process technology without substantial modifications to conventional equipment and processes. Preferably, the invention provides for an improved solar panel, which is less costly and easy to handle, using an improved solar cell. Such solar cell uses a plurality of photovoltaic regions, which are sealed within one or more substrate structures according to a preferred embodiment. In a preferred embodiment, the invention provides a method and completed solar panel structure using a plurality of solar cells including a plurality of photovoltaic strips. Also in a preferred embodiment, one or more of the solar cells have less silicon per area (e.g., 80% or less, 50% or less) than conventional solar cells. In preferred embodiments, the present method and cell structures are also light weight and not detrimental to building structures and the like. That is, the weight is about the same or slightly more than conventional solar cells at a module level according to a specific embodiment. In a preferred embodiment, the present solar cell using the plurality of photovoltaic strips, which is more robust, can be used as a “drop in” replacement of conventional solar cell structures. As a drop in replacement, the present solar cell can be used with conventional solar cell technologies for efficient implementation according to a preferred embodiment. In preferred embodiments, the present method and system provides for less use of silicon material than conventional solar cells. In a preferred embodiment, the present method is less prone to solar cell breakage, which will lead to higher yields, etc. Still further, the present method and system provides for a cost effective manufacturing process or business method, which can be implemented with conventional business entities, e.g., subcontracting, fabrication/assembly facilities, distribution. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified flow diagram illustrating a method for assembling a solar panel according to an embodiment of the present invention;

FIG. 2 is a more detailed flow diagram illustrating a method for assembling a solar panel according to an alternative embodiment of the present invention;

FIG. 3 is a simplified diagram of a solar cell according to an embodiment of the present invention;

FIG. 4 is a simplified cross-sectional view diagram of a solar cell according to an embodiment of the present invention;

FIG. 5 is a simplified cross-section of a solar cell according to an embodiment of the present invention;

FIG. 6 is a simplified cross section of a solar cell according to an alternative embodiment of the present invention;

FIG. 7 is a simplified side view diagram of an optically transparent member for a solar panel according to an embodiment of the present invention;

FIG. 8 is a top-view and side view diagram of a solar panel according to an embodiment of the present invention;

FIGS. 9 through 16 are simplified diagrams illustrating a method for assembling a solar panel according to embodiments of the present invention;

FIGS. 17 through 18 are simplified diagrams of manufacturing methods for a solar panel according to embodiments of the present invention;

FIG. 19 is a simplified diagram illustrating an embodiment of present invention for a system for manufacturing solar panels; and

FIG. 20 is a simplified functional block diagram of an embodiment of a computer 2300 as utilized according to an embodiment of the present invention.

### DETAILED DESCRIPTION OF THE INVENTION

According to the present invention, techniques related to solar energy are provided. More particularly, the present invention provides a method and resulting solar panel apparatus fabricated from a solar cell including a plurality of photovoltaic regions provided within one or more substrate members. Merely by way of example, the invention has been applied to a solar cell including the plurality of photovoltaic regions, but it would be recognized that the invention has a much broader range of applicability.

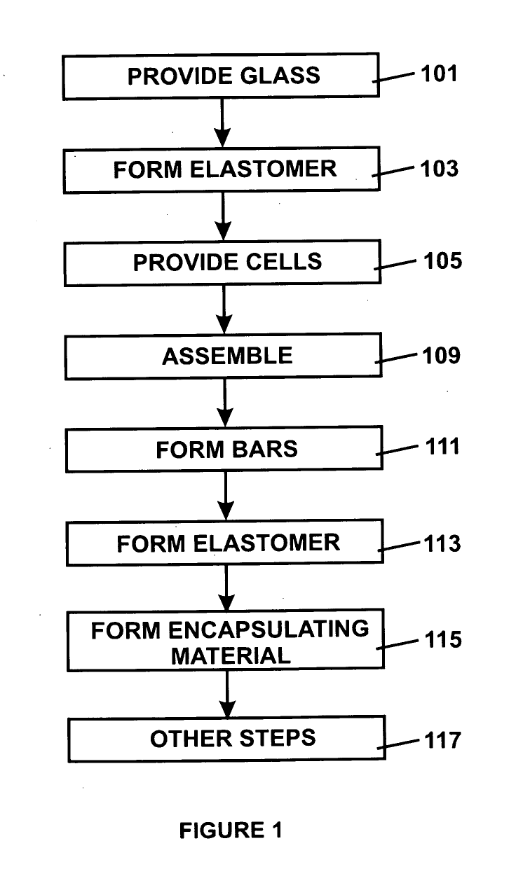

A method 100 for fabricating a solar cell panel structure according to an embodiment of the present invention may be outlined as follows and has been illustrated in FIG. 1:
1. Provide a cover glass (step 101);
2. Form a first layer of elastomer material (e.g., EVA) (step 103) overlying a top surface of the cover glass;
3. Provide a plurality of solar cells (step 105) including photovoltaic regions;
4. Assemble (step 109) the plurality of solar cells, which are coupled to each other, overlying the first layer of elastomer material;
5. Form one or more connection bars (step 111) overlying the plurality of solar cells;
6. Form a second layer of elastomer material (step 113) overlying the plurality of solar cells;
7. Form an encapsulating layer (step 115) overlying the elastomer material; and
8. Perform other steps (step 117), as desired.

The above sequence of steps provides a method according to an embodiment of the present invention. As shown, the method uses a combination of steps including a way of forming a solar panel, which has a plurality of solar cells using regions of photovoltaic material. Other alternatives can also be provided where steps are added, one or more steps are removed, or one or more steps are provided in a different sequence or repeated without departing from the scope of the claims herein. Further details of the present method and resulting structures can be found throughout the present specification and more particularly below.

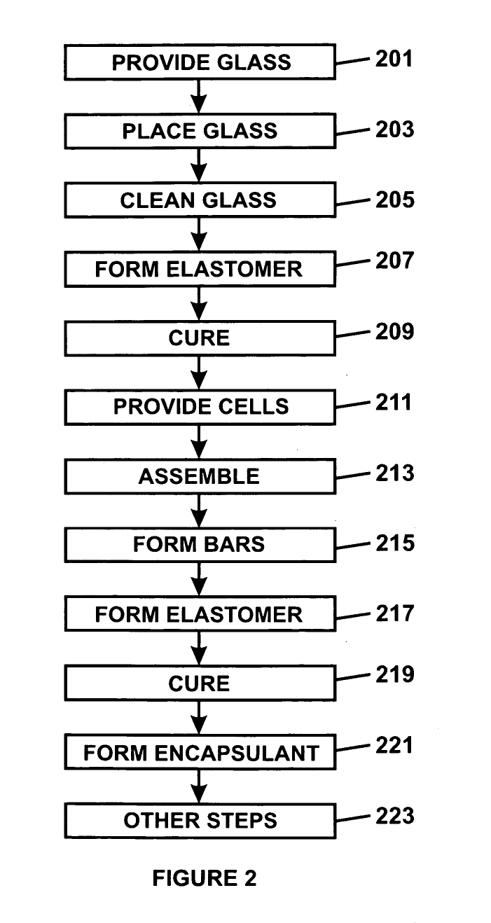

A method 200 for fabricating a solar cell panel structure according to an alternative embodiment of the present invention may be outlined as follows and has been illustrated in FIG. 2:
1. Provide a cover glass (step 201);
2. Place cover glass on workstation (step 203);
3. Clean cover glass (step 205);
4. Form via deposition a first layer of elastomer material (e.g., EVA) (step 207) overlying a top surface of the cover glass;
5. Cure first layer of elastomer material (step 209);
6. Provide a plurality of solar cells (step 211) including photovoltaic regions;
7. Assemble the plurality of solar cells (step 213), which are coupled to each other, overlying the first layer of elastomeric material;
8. Form one or more connection bars (step 215) overlying the plurality of solar cells;
9. Form via deposition a second layer (step 217) of elastomer material overlying the plurality of solar cells;
10. Cure second layer of elastomer material (step 219);
11. Form an encapsulating layer (step 221) overlying the elastomer material; and
12. Perform other steps (step 223), as desired.

The above sequence of steps provides a method according to an embodiment of the present invention. As shown, the method uses a combination of steps including a way of forming a solar panel, which has a plurality of solar cells using regions of photovoltaic material. Other alternatives can also be provided where steps are added, one or more steps are removed, or one or more steps are provided in a different sequence or repeated without departing from the scope of the claims herein. Further details of the present method and resulting structures can be found throughout the present specification and more particularly below.

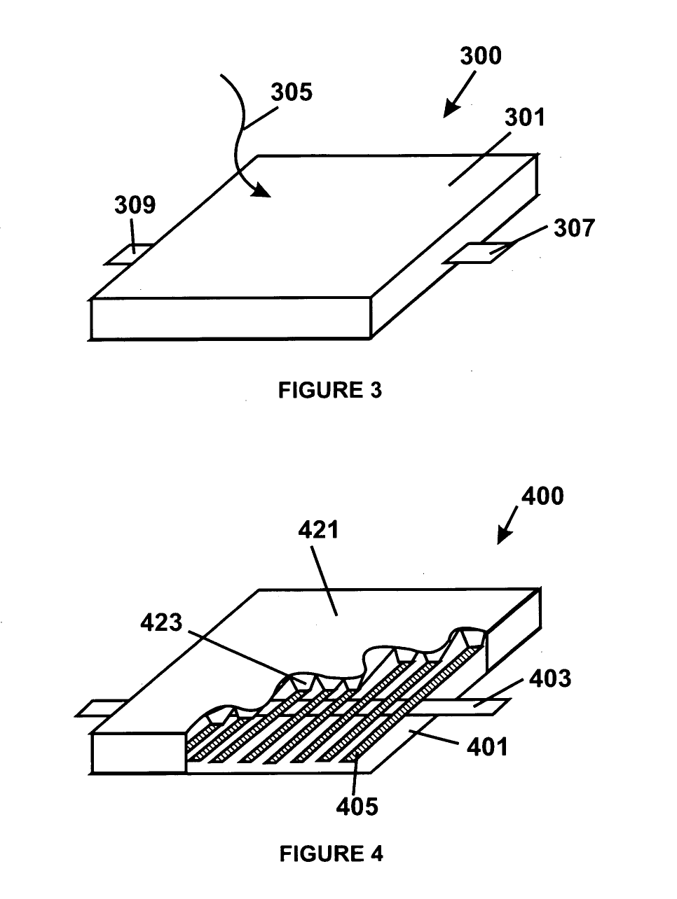

FIG. 3 is a simplified diagram of a solar cell 300 according to an embodiment of the present invention. This diagram is merely an example, which should not unduly limit the scope of the claims herein. One of ordinary skill in the art would recognize many variations, alternatives, and modifications. As shown, the solar cell 300 includes an aperture region 301, which receives electromagnetic radiation in the form of sunlight 305. The cell is often a square or trapezoidal shape, although it may also be other shapes, such as annular, circular, or any combination of these, and the like. As also shown, the cell includes a first electrical connection 309 region and a second electrical connection region 307. Each of these electrical connection regions couple to other cell structures or a bus structure that couples the cells together in a panel, which will be described throughout the present specification and more particularly below.

FIG. 4 is a simplified cross-sectional view diagram of a solar cell 400 according to an embodiment of the present invention. This diagram is merely an example, which should not unduly limit the scope of the claims herein. One of ordinary skill in the art would recognize many variations, alternatives, and modifications. As shown, the device has a back cover member 401, which includes a surface area and a back area. The back cover member also has a plurality of sites, which are spatially disposed, for electrical members 403, such as bus bars, and a plurality of photovoltaic regions.

In a preferred embodiment, the device has a plurality of photovoltaic strips 405, each of which is disposed overlying the surface area of the back cover member. In a preferred embodiment, the plurality of photovoltaic strips correspond to a cumulative area occupying a total photovoltaic spatial region, which is active and converts sunlight into electrical energy.

An encapsulating material (not shown) is overlying a portion of the back cover member. That is, an encapsulating material forms overlying the plurality of strips, and exposed regions of the back cover, and electrical members. In a preferred embodiment, the encapsulating material can be a single layer, multiple layers, or portions of layers, depending upon the application.

In a specific embodiment, a front cover member 421 is coupled to the encapsulating material. That is, the front cover member is formed overlying the encapsulant to form a multilayered structure including at least the back cover, bus bars, plurality of photovoltaic strips, encapsulant, and front cover. In a preferred embodiment, the front cover includes one or more concentrating elements 423, which concentrate (e.g., intensify per unit area) sunlight onto the plurality of photovoltaic strips. That is, each of the concentrating elements can be associated respectively with each of or at least one of the photovoltaic strips.

Upon assembly of the back cover, bus bars, photovoltaic strips, encapsulant, and front cover, an interface region is provided along at least a peripheral region of the back cover member and the front cover member. The interface region may also be provided surrounding each of the strips or certain groups of the strips depending upon the embodiment. The device has a sealed region and is formed on at least the interface region to form an individual solar cell from the back cover member and the front cover member. The sealed region maintains the active regions, including photovoltaic strips, in a controlled environment free from external effects, such as weather, mechanical handling, environmental conditions, and other influences that may degrade the quality of the solar cell. Additionally, the sealed region and/or sealed member (e.g., two substrates) protect certain optical characteristics associated with the solar cell and also protects and maintains any of the electrical conductive members, such as bus bars, interconnects, and the like. Of course, there can be other benefits achieved using the sealed member structure according to other embodiments.

In a preferred embodiment, the total photovoltaic spatial region occupies a smaller spatial region than the surface area of the back cover. That is, the total photovoltaic spatial region uses less silicon than conventional solar cells for a given solar cell size. In a preferred embodiment, the total photovoltaic spatial region occupies about 80% and less of the surface area of the back cover for the individual solar cell. Depending upon the embodiment, the photovoltaic spatial region may also occupy about 70% and less or 60% and less or preferably 50% and less of the surface area of the back cover or given area of a solar cell. Of course, there can be other percentages that have not been expressly recited according to other embodiments. Here, the terms “back cover member” and “front cover member” are provided for illustrative purposes, and not intended to limit the scope of the claims to a particular configuration relative to a spatial orientation according to a specific embodiment. Further details of the solar cell can be found throughout the present specification and more particularly below.

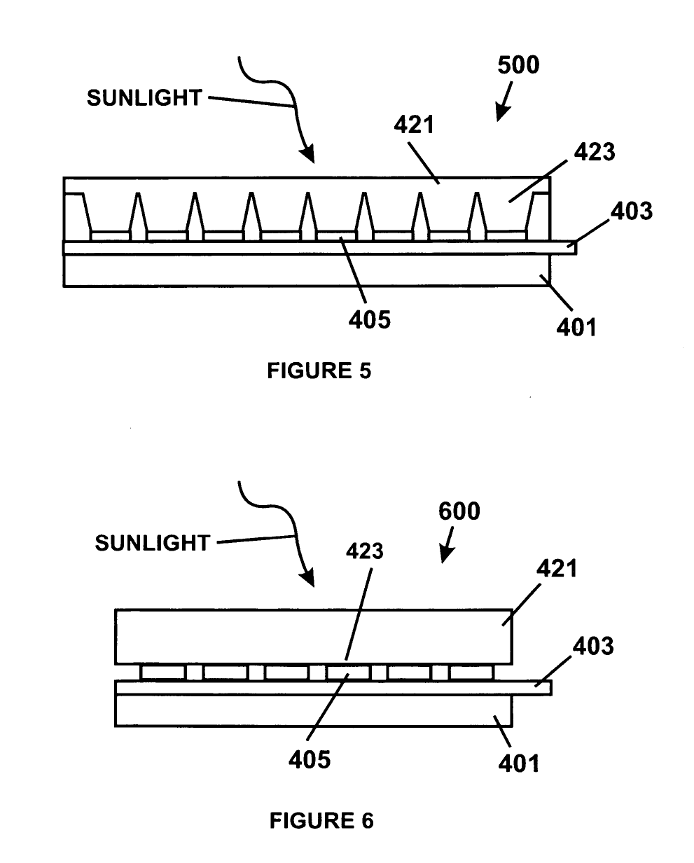

FIG. 5 is a simplified cross-section of a solar cell 500 according to an embodiment of the present invention. This diagram is merely an example, which should not unduly limit the scope of the claims herein. One of ordinary skill in the art would recognize many variations, alternatives, and modifications. Like reference numerals are used in the present diagram as other described herein, but are not intended to be limiting the scope of the claims herein. As shown, the solar cell includes a back cover 401, which has a plurality of electrical conductors 403. The back cover also includes a plurality of photovoltaic regions 405. Each of the photovoltaic regions couples to concentrator 423, which is provided on top cover member 421. Of course, there can be other variations, modifications, and alternatives.

FIG. 6 is a simplified cross section of a solar cell 600 according to an alternative embodiment of the present invention. This diagram is merely an example, which should not unduly limit the scope of the claims herein. One of ordinary skill in the art would recognize many variations, alternatives, and modifications. Like reference numerals are used in the present diagram as other described herein, but are not intended to be limiting the scope of the claims herein. As shown, the solar cell includes a back cover 401, which has a plurality of electrical conductors 403. The back cover also includes a plurality of photovoltaic regions 405. Each of the photovoltaic regions couples to concentrator 423, which is provided on top cover member 421. Of course, there can be other variations, modifications, and alternatives. Specific details on using these solar cells for manufacturing solar panels can be found throughout the present specification and more particularly below.

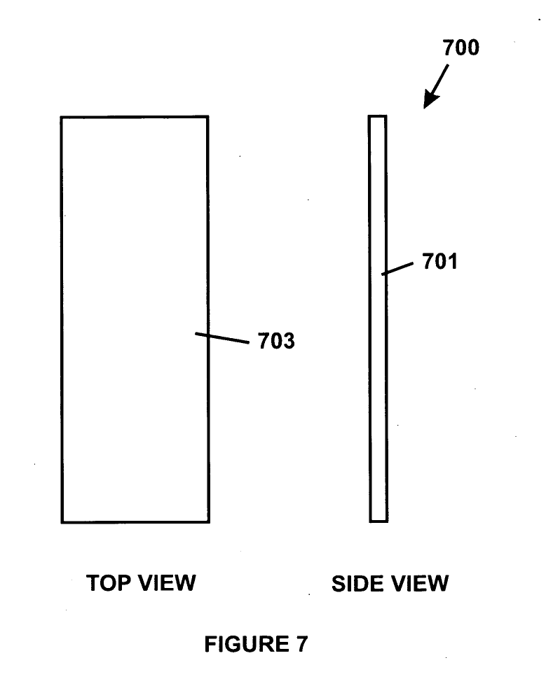

FIG. 7 is a simplified side view diagram of an optically transparent member 700 for a solar panel according to an embodiment of the present invention. This diagram is merely an example, which should not unduly limit the scope of the claims herein. One of ordinary skill in the art would recognize many variations, alternatives, and modifications. As shown, the optically transparent member 700 is illustrated in a side view diagram 701 and a top-view or back-view diagram 703. The side view diagram illustrates a member having a certain thickness, which can range from about ⅛″ or less to about ¼″ or more in a specific embodiment. Of course, the thickness will depending upon the specific application. Additionally, the member is often made of an optically transparent material, which may be composed of a single material, multiple materials, multiple layers, or any combination of these, and the like. As merely an example, the optically transparent material is called Krystal Klear™ optical glass manufactured by AFG Industries, Inc., but can be others.

As also shown, the optically transparent member has a length, a width, and the thickness as noted. The member often has a length ranging from about 12″ to greater than 130″ according to a specific embodiment. The width often ranges from about 12″ to greater than 96″ according to a specific embodiment. The member serves as an “aperture” for sunlight to be directed onto one of a plurality of solar cells according to an embodiment of the present invention. As will be shown, the member serves as a starting point for the manufacture of the present solar panels according to an embodiment of the present invention. Of course, there can be other variations, modifications, and alternatives.

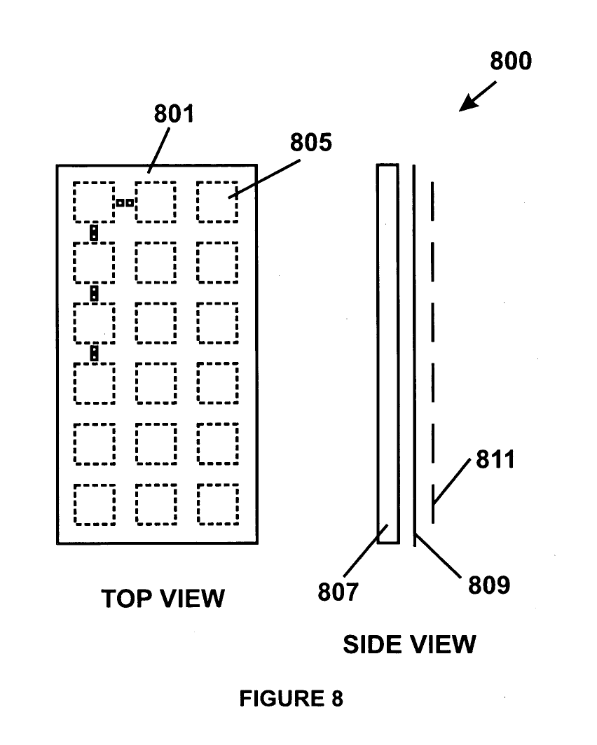

FIG. 8 is a top-view and side view diagram of a solar panel 800 according to an embodiment of the present invention. This diagram is merely an example, which should not unduly limit the scope of the claims herein. One of ordinary skill in the art would recognize many variations, alternatives, and modifications. As shown, the side-view diagram includes the optical transparent member 807, which couples to polymeric coupling material 809, which couples to a plurality of solar cells 811, among other elements. The top-view diagram illustrates the plurality of solar cells 805 and overlying optical transparent member 801. Of course, one of ordinary skill in the art would recognize many other variations, modifications, and alternatives. Further details of the present solar panel and its manufacture can be found throughout the present specification and more particularly below.

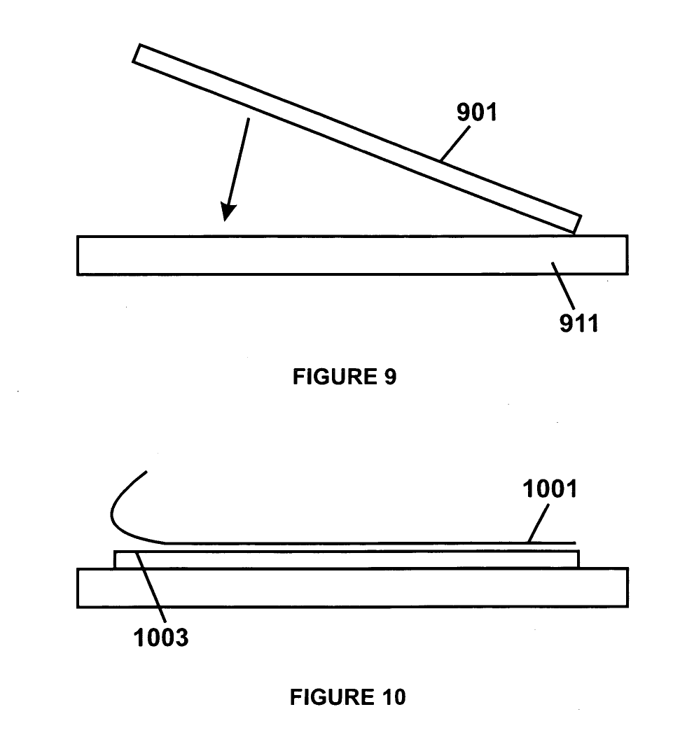

FIGS. 9 through 16 are simplified diagrams illustrating a method for assembling a solar panel according to embodiments of the present invention. These diagrams are merely examples, which should not unduly limit the scope of the claims herein. One of ordinary skill in the art would recognize many variations, alternatives, and modifications. As shown, the method begins by providing a cover glass, which is an optically transparent member. The optically transparent member has suitable characteristics, which will be described in more detail below.

That is, the member has a certain thickness, which can range from about ⅛″ or less to about ¼″ or more according to a specific embodiment. Of course, the thickness will depending upon the specific application. Additionally, the member is often made of an optically transparent material, which may be composed of a single material, multiple materials, multiple layers, or any combination of these, and the like. As merely an example, the optically transparent material is called Krystal Klear™ optical glass manufactured by AFG Industries, Inc., but can be others.

As also shown, the optically transparent member has a length, a width, and the thickness as noted. The member often has a length ranging from about 12″ to greater than 130″ according to a specific embodiment. The width often ranges from about 12″ to greater than 96″ according to a specific embodiment. The member serves as an “aperture” for sunlight to be directed onto one of a plurality of solar cells according to an embodiment of the present invention. As will be shown, the member serves as a starting point for the manufacture of the present solar panels according to an embodiment of the present invention. Of course, there can be other variations, modifications, and alternatives.

As shown, the member is provided on workstation 911. The work station can be a suitable place to process the member. The work station can be a table or in a tool, such as cluster tool, or the like. The table or tool can be in a clean room or other suitable environment. As merely an example, the environment is preferably a Class 10000 (ISO Class 7) clean room or better, but can be others. Of course, one of ordinary skill in the art would recognize many variations, alternatives, and modifications.

Depending upon the embodiment, the cover glass is processed. That is, the cover glass may be subjected to a cleaning process or other suitable process in preparation for fabricating other layers thereon. In a specific embodiment, the method cleans the cover glass using an ultrasonic bath process. Alternatively, other processes such as glass wiping with a lint free cloth may be used. The surfaces of the cover glass are free from particles and other contaminants, such as oils, etc. according to a specific embodiment. Of course, one of ordinary skill in the art would recognize many variations, alternatives, and modifications.

Referring now to FIG. 10, the method forms an encapsulating material (first layer) overlying a surface of the cover glass. This diagram is merely an example, which should not unduly limit the scope of the claims herein. One of ordinary skill in the art would recognize many variations, alternatives, and modifications. As used herein, the terms “first” and “second” are not intended to be limiting in any manner and are merely be used for reference purposes. The encapsulating material is preferably provided via deposition of a first layer of encapsulating material (e.g., EVA) overlying a top surface of the cover glass. In a specific embodiment, the encapsulating material is suitably a polymer material that is UV stable. As merely an example, the encapsulating material is a thermoplastic polyurethane material such as those called ETIMEX® film from Vistasolar containing Desmopan® film manufactured by Bayer Material Science AG of Germany, but can be others. An alternative example of such an encapsulating material is Elvax® EVA manufactured by DuPont of Delaware USA, but can be others. The encapsulating material is preferably cured (e.g., fused or cross-linked) according to a specific embodiment. In a preferred embodiment, the encapsulating material has a desirable optical property. The encapsulating material has a protecting capability to maintain moisture and/or other contaminants away from certain devices elements according to alternative embodiments. The encapsulating material also can be a filler or act as a fill material according to a specific embodiment. Depending upon the embodiment, the encapsulating material also provides thermal compatibility between different materials that are provided on either side of the encapsulating material.

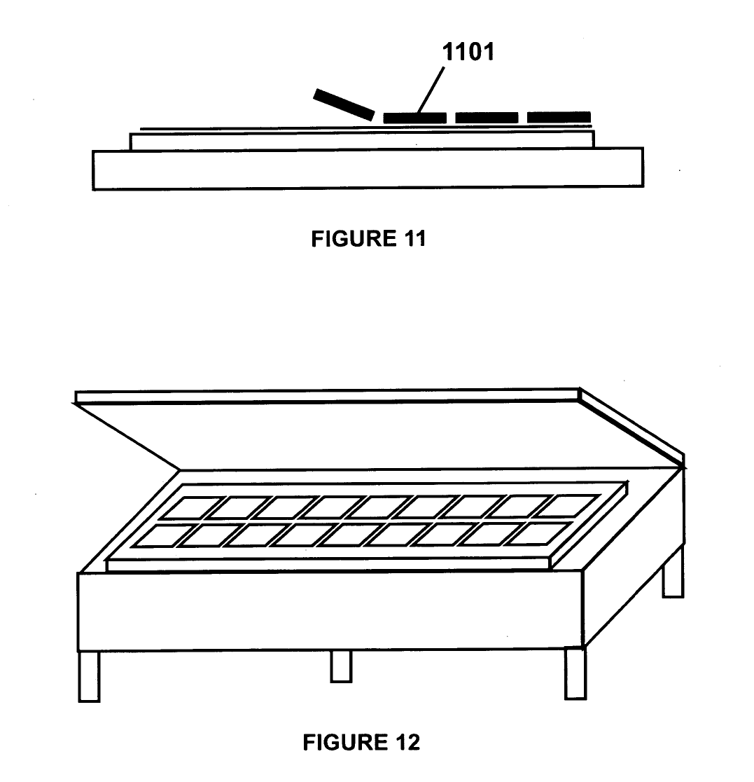

Referring now to FIG. 11, the method provides a plurality of solar cells including photovoltaic regions 1101. This diagram is merely an example, which should not unduly limit the scope of the claims herein. One of ordinary skill in the art would recognize many variations, alternatives, and modifications. Each of the solar cells include a plurality of photovoltaic regions and/or strips according to a specific embodiment. The method assembles the plurality of solar cells, which are coupled to each other, overlying the layer of encapsulating material to form a multilayered structure. As shown, the optically transparent member serves as an aperture, which couples to aperture regions of the solar cells. In a preferred embodiment, each of the solar cells is aligned to each other via a mechanical self-alignment mechanism, electrically coupling device, or other device that causes a physical location of each of the cells to be substantially fixed in spatial position along a region of the transparent member. The mechanical alignment mechanism may be a portion of the electrical connections on each of the solar cells or other portions of the solar cell depending upon the specific embodiment. In a specific embodiment, the self-alignment mechanism also keys the electrical interconnect such that the polarity between cells is always correct to prevent assembly problems. The self-alignment mechanism is designed into the cells as a “tongue and groove” or notches and nibs, or other configurations. The cells are placed next to each other such that the alignment features interlock with each other. Of course, one of ordinary skill in the art would recognize many variations, modifications, and alternatives.

In a specific embodiment, the method includes laminating the multilayered structure using a laminating apparatus, as shown in FIG. 12. This diagram is merely an example, which should not unduly limit the scope of the claims herein. One of ordinary skill in the art would recognize many variations, alternatives, and modifications. That is, the multilayered structure is subjected to suitable conditions and processes for lamination to occur, which essentially bonds the layers together according to a specific embodiment. As merely an example, a EVA laminate material is heated to a temperature of at least 150 Celsius for about 10 to 15 minutes to cure and/or cross-like the polymers in the encapsulant material according to a specific embodiment. As shown, each of the solar cells becomes substantially fixed onto surfaces of the transparent member according to a specific embodiment. Of course, one of ordinary skill in the art would recognize many variations, modifications, and alternatives.

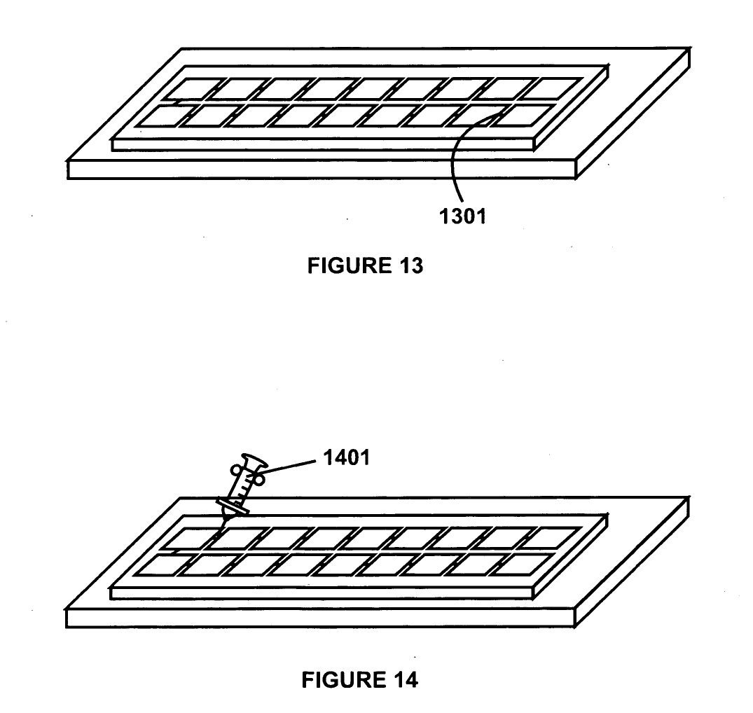

Referring to FIG. 13, the method includes forming electrical connections 1301 between one or more of the solar cells. That is, each of the solar cells may be coupled to each other in series and/or parallel depending upon a specific embodiment. In a preferred embodiment, the method couples the solar cells together in series from a first solar cell, a second solar cell, and an Nth solar cell, which is the last solar cell on the panel assembly. The first electrical connection of one cell is connected to the second electrical connection of next cell in series. In a preferred embodiment the electrical connection is made by attaching a wire or metal strip across the first and second electrical connections of adjacent cells. The wire or metal strip is then soldered at both ends to the cells' electrical connections. Alternatively, other processes such as using electrically conducting epoxies or adhesives to attach the wire or metal strip to the cells' electrical connections could be used. Of course, one of ordinary skill in the art would recognize many variations, modifications, and alternatives.

In a specific embodiment, the method forms via deposition 1401 a second layer of encapsulating material overlying the plurality of solar cells, as illustrated in the simplified diagram of FIG. 14. The encapsulating material is preferably provided via deposition of the encapsulating material overlying the electrical connections and may also be overlying backside regions of the solar cells depending upon the specific embodiment. In a specific embodiment, the encapsulating material is suitably a silicone pottant that has high electrical insulation, low water absorption, and excellent temperature stability. Other types of materials may include Parylene based materials according to a specific embodiment. As merely an example, the encapsulating material is a pottant material such as those called OR-3100 low viscosity pottant kit from Dow Corning, USA, but can be others. The encapsulating material is preferably cured according to a specific embodiment. As shown, the encapsulant material occupies regions in a vicinity of the electrical connections according to a specific embodiment. Alternatively, the method forms an encapsulating layer overlying the second elastomer material according to a specific embodiment. Of course, one of ordinary skill in the art would recognize other variations, modifications, and alternatives.

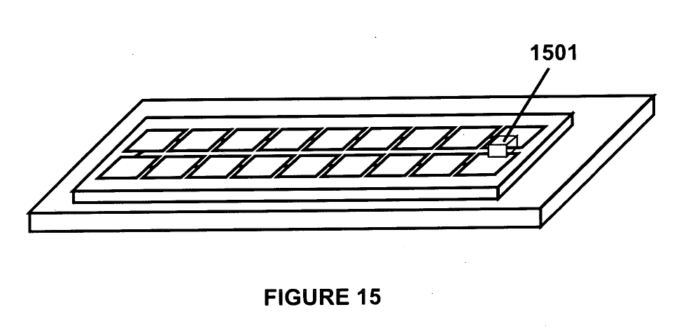

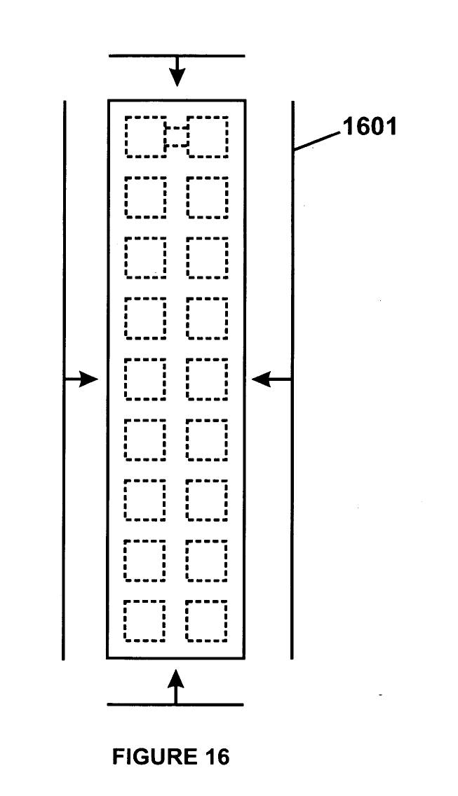

Referring now to FIGS. 15 and 16, the method assemblies one or more junction boxes 1501 onto portions of the electrical interconnects. The method also attaches one or more frame members 1601 onto edges or side portions of the optically transparent member including the plurality of solar cells. In a specific embodiment, the junction box is used to electrically connect the module to other modules or to the electrical load. The junction box contains connection terminals for the external wires and connection terminals for the internal electrical leads to the cells in the module. The junction box may also house the bypass diode used to protect the module when it is shaded. The junction box is placed on the back or side of the module such that connections to the first and last cells in the interconnected series of cells is easily accessible. The junction box is attached and sealed to the module using RTV silicon. Electrical connections are made through soldering, screw terminals, or as defined by the junction box manufacturer. As merely an example, the SOLARLOK interconnect system from Tyco Electronics could be used to provide the junction box and interconnects, but can be others. The module frame is attached to the sides of the module to provide for easy mounting, electrical grounding, and mechanical support. In a preferred embodiment, the frames are made from extruded aluminum cut to length. Two lengths would have counter-sunk holes to provide for screw passage. The remaining two lengths would have predrilled or hollow area for the screws to fasten. The extruded aluminum would contain channels designed to capture the laminate. A foam strip is placed around the edges of the module and then the extruded aluminum channel is pressed over the foam. When all four sides are properly located, two screws at each corner are inserted to hold the frame together. In an alternate embodiment, the frame could be provided by a molded polymer with or without a metal support structure, As shown, the present method forms a resulting structure that may exposed certain backside regions of the solar cells, which are characterized by sealed backside regions, according to specific embodiments. Of course, one of ordinary skill in the art would recognize many variations, modifications, and alternatives.

The above sequence of steps provides a method according to an embodiment of the present invention. As shown, the method uses a combination of steps including a way of forming a solar panel, which has a plurality of solar cells using regions of photovoltaic material. Other alternatives can also be provided where steps are added, one or more steps are removed, or one or more steps are provided in a different sequence or repeated without departing from the scope of the claims herein.

It is also understood that the examples and embodiments described herein are for illustrative purposes only and that various modifications or changes in light thereof will be suggested to persons skilled in the art and are to be included within the spirit and purview of this application and scope of the appended claims. That is, the present panel structure includes a solar cell with a concentrating element provided thereon. Such concentrating element or elements may be provided (e.g., integrated) on a cover glass of the solar panel according to a specific embodiment. Of course, there can be other variations, modifications, and alternatives.

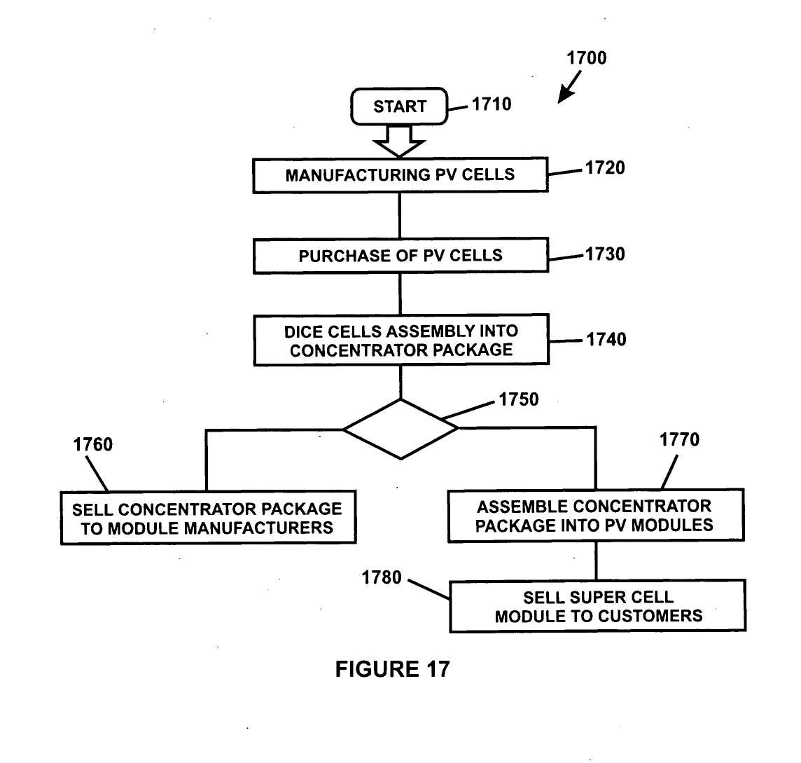

A method 1700 for fabricating a solar cell panel structure according to an embodiment of the present invention may be outlined as follows and has been illustrated in FIG. 17. This diagram is merely an example, which should not unduly limit the scope of the claims. One of ordinary skill in the art would recognize many variations, alternatives, and modifications. As an example, embodiment described in FIG. 17 involves a first manufacturing entity, a second manufacturing entity, a third manufacturing entity, and customers. Of course, there can be other variations, modifications, and alternatives.

In this example, the first manufacturing entity produces photovoltaic solar cells, the second manufacturing entity produces concentrator packages, the third manufacturing produces solar modules using either photovoltaic solar cells or super cells, and the customers are the end users for solar modules. As an example, the first manufacturing entity is a solar cell company and the second manufacturing entity is a solar module company. As shown, the method begins at start, step 1710. At step 1710, the second manufacturing entity has both dicing and assembly line ready, but do not have photovoltaic solar cells to work with. However, the first manufacturing entity produces photovoltaic cells at step 1720. As an example, the first manufacturing entity has fabrication facilities and capacity to produce large photovoltaic cells. Next, at step 1730 the second manufacturing entity purchases photovoltaic cells from the first manufacturing entity at a purchasing value. For example, the second manufacturing entity purchases photovoltaic cells directly from the first manufacturing entity at bulk quantity with low per unit monetary value. As another example, the second manufacturing entity purchases photovoltaic cells from retail distribution channels for relatively higher per unit monetary value.

After acquiring photovoltaic cells through purchasing at step 1730, the second manufacturing entity dices photovoltaic cells into photovoltaic regions at step 1740. According to an embodiment of the present invention, saw operation may be used for dicing. Merely by way of an example, a photovoltaic region may be a photodiode in a strip shape. It is to be appreciated that a photovoltaic region may also be circular, square, triangular, or any other shape to accommodate different types of application. Other variations, modifications, and alternatives can also exist.

At step 1740, the second manufacturing entity assembles contractor packages using photovoltaic regions. In a preferred embodiment, a concentrator package includes one or more photovoltaic regions, encapsulant, one or more concentrator elements, one or more substrates, and a back cover. During the assembly process, photovoltaic cells are respectively coupled to contractor elements with encapsulating material provided between each of the photovoltaic regions and each of the concentrator elements. In a preferred embodiment, the encapsulating material can be a single layer, multiple layers, or portions of layers, depending upon the application. Photovoltaic cells are additionally spatially disposed overlying substrate surfaces. According to a preferred embodiment, the substrate surfaces provide sealing to photovoltaic regions and optical characteristics thereof. The photovoltaic cells are then secured to back covers. In a preferred embodiment, the total photovoltaic spatial region occupies a smaller spatial region than the surface area of the back cover. That is, the total photovoltaic spatial region uses less silicon than conventional solar cells for a given solar cell size. In a preferred embodiment, the total photovoltaic spatial region occupies about 80% and less of the surface area of the back cover for the individual solar cell. According to an embodiment, concentrator packages have substantially the same dimensions to photovoltaic cells. It is to be appreciated that the dimensions of concentrator packages, being the same as conventional photovoltaic cells, provides modularity and allows contractor packages to be used interchangeability with conventional photovoltaic cells.

After assembly, the second manufacturing entity at step 1750 decides whether to sell contractor packages to the third manufacturing entity or to assemble concentrator packages into photovoltaic modules. In a preferred embodiment, the second manufacturing entity at step 1750 decides to sell contractor packages to the third manufacturing entity and the method 1700 proceeds to step 1760. In an alternative preferred embodiment, the second manufacturing entity at step 1750 decides to assemble concentrator packages into photovoltaic modules and the method 1700 proceeds to step 1760.

At step 1750, the second manufacturing entity sells concentrator packages to the third manufacturing entity at a selling value. In a preferred embodiment, the selling value is less than 79% of the purchasing value. It is to be appreciated that the second manufacturing entity, in the preferred embodiment, is able to make a profit from the method 1700. For example, a solar module company may purchase a photovoltaic cell at $100 each. Using the method 1700, the solar module company produces four concentrator packages selling for $50 each, and the dicing and assembling costs $50. The solar module company is able to profit $50 from the purchased photovoltaic cell. In a preferred embodiment, the third manufacturing entity produces solar modules, which is ready to be used by consumers, using concentrator packages.

At step 1760, the second manufacturing entity assembles concentrator packages into solar modules. According to an embodiment, a solar module includes a plurality of housing for concentrator packages or photovoltaic cells, providing electrical connections. As an example, a solar module produces electricity that is ready to be used in a variety of applications.

After assembling concentrator packages into solar modules, the second manufacturing entity sells solar modules to customers at step 1780. It is to be appreciated that, according to an embodiment, the solar modules produced using concentrator packages sells a price lower than that of solar modules produced using conventional photovoltaic cells.

The above sequence of steps provides a method according to an embodiment of the present invention. As shown, the method uses a combination of steps including a way of forming a solar panel, which has a plurality of solar cells using regions of photovoltaic material. Other alternatives can also be provided where steps are added, one or more steps are removed, or one or more steps are provided in a different sequence or repeated without departing from the scope of the claims herein. Further details of the present method and resulting structures can be found throughout the present specification.

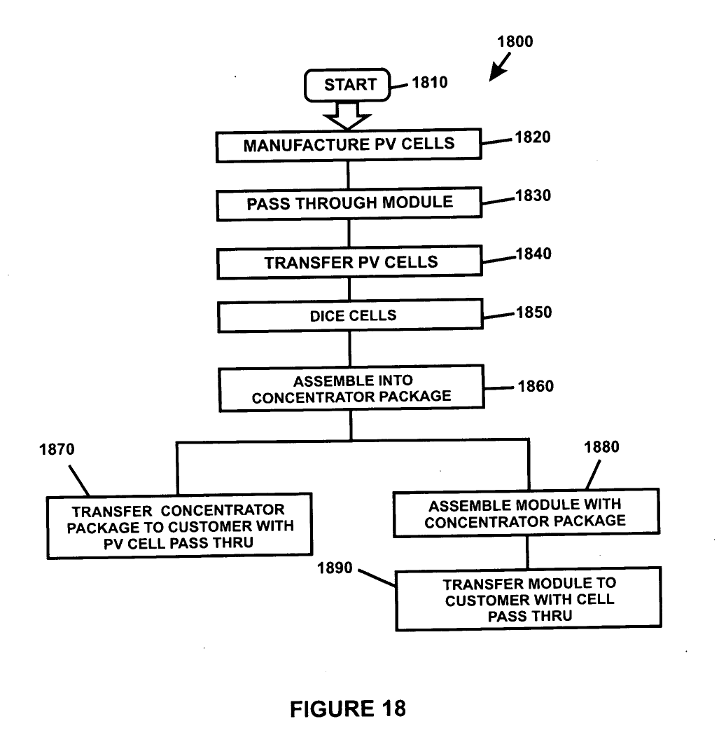

A method 1800 for fabricating a pass through solar cell panel with structure according to an embodiment of the present invention may be outlined as follows and has been illustrated in FIG. 18. This diagram is merely an example, which should not unduly limit the scope of the claims. One of ordinary skill in the art would recognize many variations, alternatives, and modifications. As an example, embodiment described in FIG. 18 involves a first manufacturing entity, a second manufacturing entity, a third manufacturing entity, and customers. In this example, the first manufacturing entity produces photovoltaic solar cells, the second manufacturing entity produces concentrator packages, the third manufacturing produces solar modules using either photovoltaic solar cells or super cells, and the customers are the end users for solar modules. As another example, customers may be suppliers of solar cells. According to an embodiment, the first manufacturing entity is a solar cell company and the second manufacturing entity is a solar module company. As shown, the method begins at start, step 1810. At step 1810, the second manufacturing entity has both dicing and assembly line ready, but do not have photovoltaic solar cells to work with. However, the first manufacturing entity produces photovoltaic cells at step 1820. As an example, the first manufacturing entity has fabrication facilities and capacity to produce large photovoltaic cells. Next, at step 1830 where a pass through module is implemented, photovoltaic cells are “passed through” to the second manufacturing entity according an existing or negotiated agreements. According to an embodiment, the first manufacturing entity may pay fee to the second manufacturing entity to dice photovoltaic cells into photovoltaic regions and assemble photovoltaic regions into concentrator packages. According to an alternative embodiment, customers provide the second manufacturing entity photovoltaic cells, pay for the second manufacturing entity to dice and assemble photovoltaic packages.

After step 1830, photovoltaic cells are transferred to the second manufacturing entity. According the present embodiment of the invention, the second manufacturing entity does own the transferred photovoltaic cells, but only in possession of photovoltaic cells for the purpose of dicing and assembling. In return for the manufacturing work performed, the second manufacturing entity receives a fee, which may be negotiated or determined at step 1820.

After acquiring photovoltaic cells at step 1840, the second manufacturing entity dices photovoltaic cells into photovoltaic regions at step 1750. According to an embodiment of the present invention, saw operation may be used for dicing. Merely by way of an example, a photovoltaic region may be a photodiode in a strip shape. It is to be appreciated that a photovoltaic region may also be circular, square, triangular, or any other shape to accommodate different types of application. At step 1760, the second manufacturing entity assembles contractor packages using photovoltaic regions. In a preferred embodiment, a concentrator package includes one or more photovoltaic regions, encapsulant, one or more concentrator elements, one or more substrates, and a back cover. During the assembly process, photovoltaic cells are respectively coupled to contractor elements with encapsulating material provided between each of the photovoltaic regions and each of the concentrator elements. In a preferred embodiment, the encapsulating material can be a single layer, multiple layers, or portions of layers, depending upon the application. Photovoltaic cells are additionally spatially disposed overlying substrate surfaces. According to a prefer embodiment, the substrate surfaces provide sealing to photovoltaic regions and optical characteristics thereof. The photovoltaic cells are then secured to back covers. In a preferred embodiment, the total photovoltaic spatial region occupies a smaller spatial region than the surface area of the back cover. That is, the total photovoltaic spatial region uses less silicon than conventional solar cells for a given solar cell size. In a preferred embodiment, the total photovoltaic spatial region occupies about 80% and less of the surface area of the back cover for the individual solar cell. According to an embodiment, concentrator packages have substantially the same dimensions to photovoltaic cells. It is to be appreciated that the dimensions of concentrator packages, being the same as conventional photovoltaic cells, provides modularity and allows contractor packages to be used interchangeability with conventional photovoltaic cells.

After assembling concentrator packages at step 1860, the second manufacturing entity can either transfer the concentrator package to customers and/or a third entity, or further assemble concentrator packages into solar modules that are ready to be used and then transfer solar modules to the third entity. According to an embodiment, the second entity transfer assembled concentrator packages to a third entity at step 1870. As an example, the third entity may be a third manufacturing entity that uses concentrator packages to make solar panels. As another example, the third entity may be the first manufacturing entity had the second manufacturing entity to perform dicing and assembling at a fee, and then use concentrator packages to manufacture solar panels.

According to an alternative embodiment of the present invention, the second entity assembles concentrator packages into solar module at step 1880. According to an embodiment, a solar module includes a plurality of housing for concentrator packages or photovoltaic cells, providing electrical connections. As an example, a solar module produces electricity that is ready to be used in a variety of applications.

After step 1880, the second manufacturing entity transfer assembled solar modules to customers 1890. According to an embodiment, where the second manufacturing entity receives photovoltaic cells from customers for manufacturing solar modules, the second manufacturing entity collect a fee from customers for dicing and assembling. According to an alternative example, the first manufacturing entity may have existing purchasing orders from customers for solar panels, use the second manufacturing entity to make solar modules from photovoltaic cells at a certain price, and the second manufacturing entity transfer solar modules to customers to fulfill the existing purchasing orders.

The above sequence of steps provides a method according to an embodiment of the present invention. As shown, the method uses a combination of steps including a way of forming a solar panel, which has a plurality of solar cells using regions of photovoltaic material. Other alternatives can also be provided where steps are added, one or more steps are removed, or one or more steps are provided in a different sequence or repeated without departing from the scope of the claims herein. Further details of the present method and resulting structures can be found throughout the present specification.

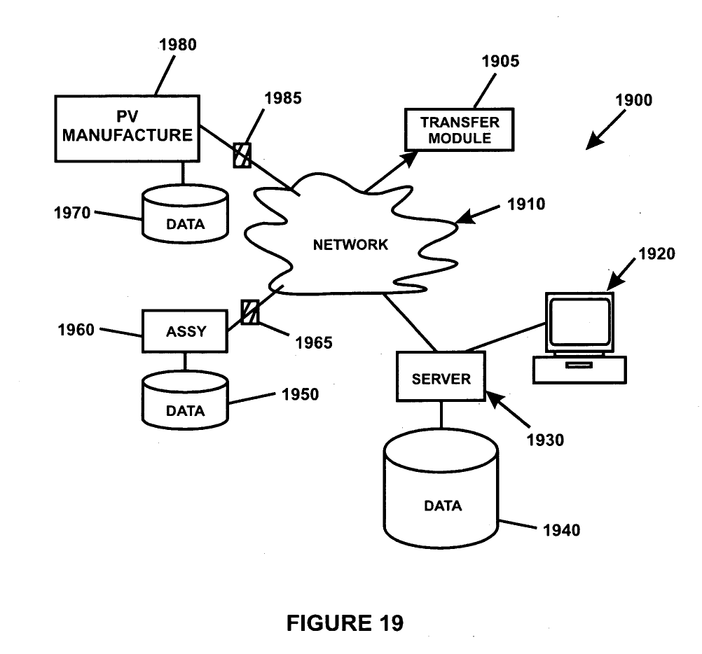

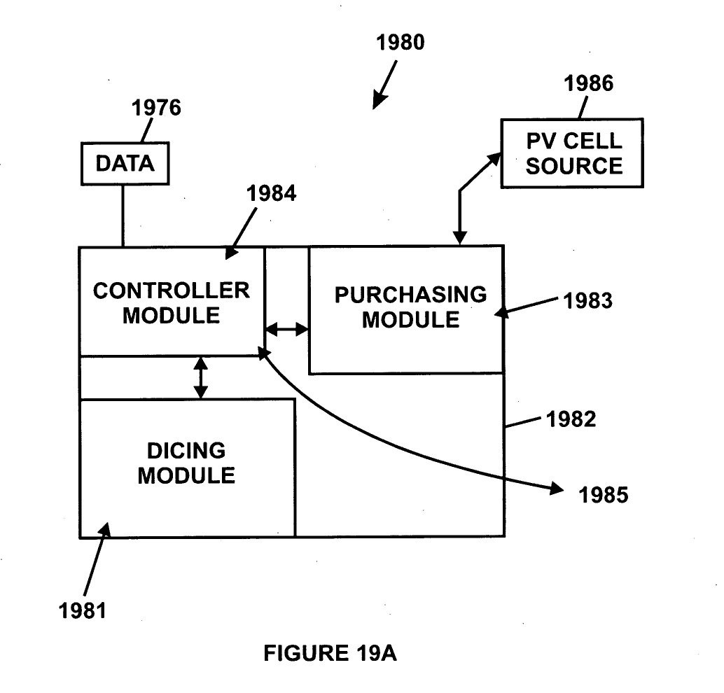

FIG. 19 is a simplified diagram illustrating an embodiment of present invention for a system for manufacturing solar panels. This diagram is merely an example, which should not unduly limit the scope of the claims. One of ordinary skill in the art would recognize many variations, alternatives, and modifications. The manufacturing system 1900 includes, inter alia, a transfer module, a network 1910, a user terminal 1920, a server 1930, a server data storage 1940, an assembly module 1960, an assembly data storage 1950, an assembly network interface 1965, a photovoltaic cell manufacturing module 1980, a photovoltaic data storage 1970, and a photovoltaic network interface 1985.

According to an embodiment, the server 1930 maintains a variety of data related to manufacturing photovoltaic modules, and the server 1930 stores data at the server data storage 1940. As an example, the server 1930 stores settings related to manufacturing solar panels. The settings may includes, but not limited to, the dimension of the photovoltaic regions to be manufactured, the solar module to be used in assembly. The server 1930 is connected to the user terminal 1920. As an example, the user terminal may be a computer that offers user interface such as a monitor, a keyboard, and a mouse. A user may use the user terminal 1920 to communicate with the server 1930, which in turn could create new settings or modify existing settings stored in the server data storage 1940. According to an embodiment, a user may be an operator at a solar panel manufacturing facility, and the may modify the pace of manufacturing operation. According to another embodiment, a user may be a customer who use the user terminal 1920 to set the shape of photovoltaic regions to be dice into to suit his needs.

The server 1930 is connected to the network 1910 to communicate with other modules for manufacturing solar panels. The server 1930 is connected to, inter alia, a photovoltaic cell manufacturing module 1980 via the photovoltaic network interface 1985. According to an embodiment, the photovoltaic cell manufacturing module 1980 is additionally connected to a photovoltaic data storage 1970, which stores settings for manufacturing photovoltaic cells.

FIG. 19A illustrates an exemplary photovoltaic cell manufacturing module as utilized according to an embodiment of the present invention. The photovoltaic cell manufacturing module 1980 includes, inter alia, a controller module 1984, a purchasing module 1983, and a dicing module 1981. Via the network interface 1985, the controller module 1984 obtains settings from the network 1910 via the photovoltaic network interface 1985. Merely by way of an example, the settings include, but not limited to, price range for purchasing photovoltaic cells, dimensions and shapes for dicing. According to an embodiment, the controller module 1984 stores local settings to the photovoltaic data storage 1970.

The controller module 1984 is designed to control the purchasing module 1983 and the dicing module 1981 according to available settings. The purchasing module 1983 from a photovoltaic cell source 1986 according to the settings, which may include price, quantity, and supplier source. According to an embodiment, the photovoltaic cell source 1986 is a photovoltaic cell manufacturer that is willing to sell manufactured photovoltaic cells at a pre-negotiated price. According to another embodiment, the photovoltaic cell source 1986 is an individual customer who supplies photovoltaic cells for modification or refurbishing. Yet according to another embodiment, the photovoltaic cell source 1986 is a solar panel retail stores that photovoltaic cells that may be new or used.

The controller module 1984 additionally controls the dicing module 1981 according to available settings. As an example, dicing is accomplish by sawing or laser cutting. After the purchasing module 1983 acquires photovoltaic cells, the dicing module 1981 dices those cells into photovoltaic regions according to settings. According to one embodiment, photovoltaic cells are diced into photovoltaic regions in rectangular shapes. According to another embodiment where photovoltaic regions are to be fitted into circular solar panels, photovoltaic regions are in the shape of long strips with arc shape at the boundary, and the width of the strip is also in accordance to settings.

Now referring back to FIG. 19. After photovoltaic cells are diced into photovoltaic regions, the assembly module 1960 assembles photovoltaic regions into concentrator packages. The assembly module 1960 acquires settings for the assembling process from the network 1910 via the assembly network interface 1965. Settings are stored at the assembly data storage 1950, which also store data for local settings. As an example, the assembly data storage 1950 stores the setting for spatial placement of photovoltaic regions according to settings obtained over the network 1910, and local settings such as the function of a particular assembly line. The assembly module 1960 assembles concentrator packages using, inter alia, photovoltaic regions and concentrators. According to an embodiment, the assembly module 1060 attaches photovoltaic regions to back members of a concentrator package and attaches concentrators on top of photovoltaic regions. According to an embodiment, the assembly module 1950 additionally assembles solar panels using concentrator packages by attaching one ore more concentrator packages into solar panel bodies.

After assembling, concentrator packages or solar panels are transferred to another entity by the transferring module 1905. The transferring module 1905 obtains settings from the network 1910. By way of an example, settings may include selling price, quantity, and vendee for concentrator packages. According to an embodiment, the price for a concentrator package is less than 79% of the price of a photovoltaic cell. The transfer module 1905 is designed to transfer concentrator packages or solar panels to another entity, which may be a customer, a retail store, or a solar penal manufacturer.

As discussed above and further emphasized here, FIG. 19 merely provides an example, which should not unduly limit the scope of the claims. One of ordinary skill in the art would recognize many variations, alternatives, and modifications. For example, the photovoltaic data storage 1970 may be removed and the photovoltaic manufacturing module obtains and stores settings, both from the server 1930 and local, at the data storage 1940.

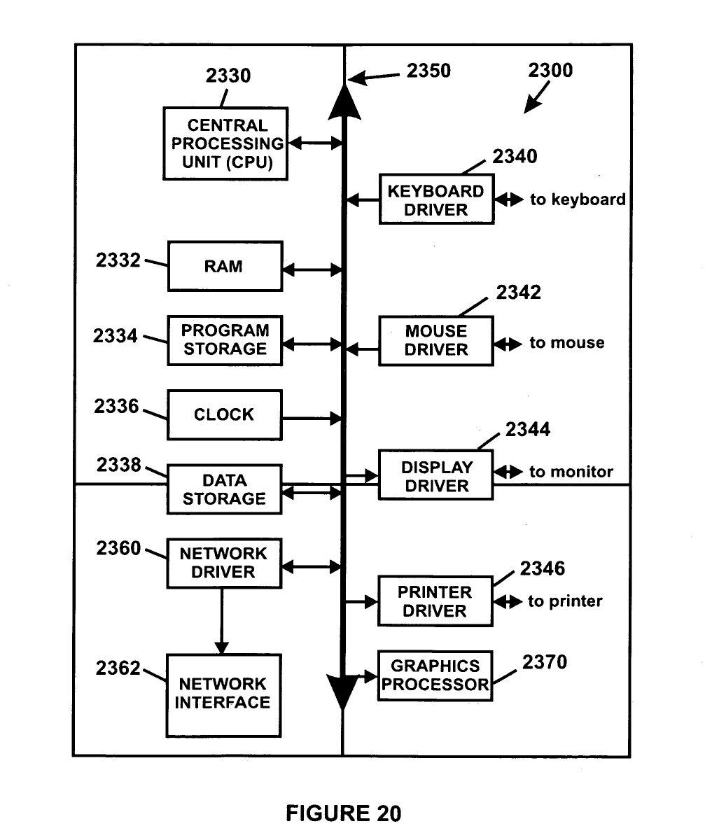

FIG. 20 is a simplified functional block diagram of an embodiment of a computer 2300 as utilized according to an embodiment of the present invention. For example, the user terminal 1920 in FIG. 19 may be implemented using the computer 2300. This diagram is merely an example, which should not unduly limit the scope of the claims. One of ordinary skill in the art would recognize many variations, alternatives, and modifications.

The computer 2300 can include a Central Processing Unit (CPU) 2330 coupled to one or more associated devices over a bus 2350. The CPU 2330 can be a general purpose processor a Reduced Instruction Set Computer (RISC) processor, or a combination of processors that can include, for example, a general purpose processor and a digital signal processor.

Although the bus 2350 is shown as a single bus, the bus 2350 can include multiple buses or communication links. For example, the computer 2300 can implement a first bus that is configured to couple the CPU 2330 to local memory, such as RAM 2332. The computer 330 can also include one or more additional buses that are used to couple the CPU 2330 to peripheral devices.

The CPU 2330 can be configured to access program storage 2334 to retrieve and execute an application stored therein. Program storage 2334 can be any type of memory, and can be implemented as internal memory or removable memory. For example, program storage can include a hard disk, ROM, or some other type of memory.

The computer 2300 can also include RAM 332 and data storage 2336 typically used for temporary storage of data. The combination of RAM 2332, program storage 2334, and data storage 2336 can be configured as the data storage 1940 shown in FIG. 19. The computer 2300 can include a clock 2336 or time keeping device configured to track time for applications that are time or date related.

The computer 2300 can also include one or more peripheral devices configured as input/output (I/O) devices or as devices supporting or otherwise related to I/O devices. The peripheral devices can include a network driver 2360 coupled to the bus 2350 and configured to communicate with a network interface device 2362. The network interface device 2362 can be configured to interface the computer 2300 with a network, such as the network 1910 shown in the system of FIG. 19.

The peripheral devices can also include a keyboard driver 2340 coupled to the bus 2350 that is configured to interface a keyboard to the computer 2300. Similarly, the computer 2300 can include a mouse driver 2342, display driver 2344, and printer driver 2346.

The computer 2300 can also include a separate graphics processor 2370 configured to operate with graphics intensive applications in order to reduce the processing load on the CPU 2330. In some embodiments, the graphics processor 2370 can be implemented with the display driver 2344, for example, in a graphics card.

The present invention provide various advantages. It is to be appreciated that certain embodiments of the present inventions makes it possible to manufacture solar panels at a reduced costs. As a result, on consumer end acquiring and using solar panels becomes more affordable. At the end, consumers are more likely to use solar panels and burning of fossil fuels will be reduced.

It is understood the examples and embodiments described herein are for illustrative purposes only and that various modifications or changes in light thereof will be suggested to persons skilled in the art and are to be included within the spirit and purview of this application and scope of the appended claims.

What is claimed is:

1. A method for manufacturing solar panels comprising:
purchasing a first photovoltaic solar cell from a first entity for a first value;
dicing the photovoltaic solar cell into a plurality of photovoltaic regions, each of the photovoltaic regions being characterized as a photodiode;
assembling a second photovoltaic solar cell, the second photovoltaic solar cell comprising a first substrate member including a first substrate surface, one or more photovoltaic regions spatially disposed overlying the first substrate surface; one or more concentrator elements respectively coupled to the one or more photovoltaic regions; and an encapsulating material provided between each of the photovoltaic regions and each of the concentrator elements;
transferring the second photovoltaic solar cell to a second entity for a second value, the second value being less than 79% of the first value.

2. The method of claim 1 further comprising using the second photovoltaic solar cell in manufacturing a solar panel apparatus.

3. The method of claim 2 wherein the using comprises coupling the second photovoltaic solar cell to a optically transparent member.

4. The method of claim 3 further comprising transferring the solar panel apparatus to a third entity for a third value.

5. The method of claim 4 wherein the third value is less than a fourth value, the fourth value being associated with a second solar panel including a plurality of the first photovoltaic cells.

6. The method of claim 1 wherein the dicing comprising a saw operation.

7. The method of claim 1 wherein the first photovoltaic solar cell is characterized by a first dimension and a second dimension, the first dimension corresponding to a first length and the second dimension corresponding to a first width; wherein the second photovoltaic cell is characterized by a third dimension and a fourth dimension, the third dimension corresponding to a second length and the fourth dimension corresponding to a second width, the first length being substantially equal to the second length, and the first width being substantially equal to the second width.

8. The method of claim 1 wherein the first entity is a solar cell company and the second entity is a solar module company.

9. The method of claim 1 wherein the first value is associated with a first monetary value.

10. The method of claim 1 wherein the second value is associated with a second monetary value.

11. A method for manufacturing solar panels comprising:
transferring a first photovoltaic solar cell from a first entity to a second entity at a first time;
storing the first photovoltaic solar cell at the second entity;
dicing the photovoltaic solar cell into a plurality of photovoltaic regions, each of the photovoltaic regions being characterized as a photodiode;
assembling a second photovoltaic solar cell, the second photovoltaic solar cell comprising a first substrate member including a first substrate surface, one or more photovoltaic regions spatially disposed overlying the first substrate surface; one or more concentrator elements respectively coupled to the one or more photovoltaic regions; and an encapsulating material provided between each of the photovoltaic regions and each of the concentrator elements; and
transferring the second photovoltaic solar cell from the second entity to a third entity;
transferring a first value from the first entity to the second entity, the first value being associated with at least the assembling the second photovoltaic cell by the second entity.

12. The method of claim 11 wherein the third entity is the second entity.

13. The method of claim 11 wherein the third entity is a panel manufacturer.

14. The method of claim 11 wherein the second entity does not own the photovoltaic solar cell.

15. The method of claim 11 wherein the third entity is a consumer.

16. The method of claim 11 wherein the first entity is a photovoltaic solar cell manufacturer.

17. The method of claim 11 further comprising coupling the second photovoltaic cell to an optically transparent member to form a solar cell panel assembly.

18. The method of claim 17 further comprising transferring the solar panel assembly to a third entity for a second value.

19. The method of claim 11 the first value is associated with a first monetary value.

20. A system for manufacturing solar panels comprising:
a manufacturing network configured to exchange data;
a server configured to store and provide data for a plurality of manufacturing settings, the server being connected to the manufacturing network;
a user terminal configured to provide user interface for a user to create and modify the plurality of manufacturing settings;
one or more computer memories coupled to the manufacturing network, the one or more memories including:
a purchasing module configured to purchase a photovoltaic cell from a first entity in accordance to the plurality of manufacturing settings, the purchasing module obtaining the plurality of manufacturing settings from the server over the manufacturing network;
a dicing module configured to dice first photovoltaic cell into a first plurality of photovoltaic regions associated with a first predetermined photovoltaic shape in accordance to the plurality of manufacturing settings, the dicing module obtaining the plurality of manufacturing settings from the server over the manufacturing network;
an assembling module configured to assemble a second photovoltaic cell using one of more photovoltaic regions in accordance to the plurality of manufacturing settings, the assembling module obtaining the plurality of manufacturing settings from the server over the manufacturing network; and
a transferring module configured to transfer the second photovoltaic cell to a second entity for a second value in accordance to the plurality of manufacturing settings, the second value being less than 79% of the first value, the transferring module obtaining the plurality of manufacturing settings from the server over the manufacturing network.

21. The system of claim 20 wherein the user terminal is a computer.

22. The system of claim 20 wherein the user is a customer.

23. The system of claim 20 wherein the user is a factory operator.

24. The system of claim 20 wherein the first entity is a solar cell company and the second entity is a solar module entity.

25. The system of claim 20 wherein the first entity is a first consumer and the second entity is a second consumer.
